(19) United States
(12) Patent Application Publication
(10) Pub. No.: US 2020/0272975 A1
(43) Pub. Date: Aug. 27, 2020

(54) System and Method for Employee Recognition Platform

(71) Applicants: Jason Dumois, Hagerstown, MD (US); Steve Springfield, Austin, TX (US); JJ Buettgen, Winter Park, FL (US)

(72) Inventors: Jason Dumois, Hagerstown, MD (US); Steve Springfield, Austin, TX (US); JJ Buettgen, Winter Park, FL (US)

(21) Appl. No.: 16/285,540

(22) Filed: Feb. 26, 2019

(51) Int. Cl. G06Q 10/06; G06Q 30/02; H04L 29/08

(52) U.S. Cl. CPC G06Q 10/06398; H04L 67/306; G06Q 30/0282

(57) ABSTRACT

A recognition platform for recognizing a worker's performance. A worker is assigned a unique identifier to unambiguously identify the worker and is further assigned a worker profile residing on the recognition platform to record recognition information. A customer wishing to recognize a worker, using a device like a smart phone or a tablet, acquires the worker's identifier and sends the identifier to an access device. The access device then retrieves, from a worker database that associates the identifier to the worker, the access information of the worker's profile that resides on the recognition platform, and sends the access information back to the customer's device. The customer, using the access information, then accesses the recognition platform to input the recognition data. The recognition data associated with each worker is stored in a recognition database. A manager or the worker may also access the recognition platform and review the recognition information and have the option to share on social media

### BACKGROUND OF THE INVENTION

### I. Field of the Invention

The invention described here generally relates to a recognition system and methods by which a customer may recognize a worker for the worker's performance.

### II. Related Art

Recognition and reward systems are used by employers or companies to incentivize performance by their employees. In some recognition and reward systems, reward tokens may be given to employees and may be “cashed in” for actual products. However, many of the existing recognition and reward systems require apparatus held by both the customers and the workers, and require complex data structures and computer configurations. This creates barriers for employers to implement such a system and makes it burdensome for the customers to use such recognition and reward systems. Therefore, a recognition system that is straight forward and easy to implement and use is needed. Such a system could recognize a worker's performance, as well as reward, educate, and inspire the worker. Such a recognition system could also decrease employee turnover, reduce the cost to the employer, and improve the employer's profits.

### BRIEF DESCRIPTION OF THE FIGURES

FIG. 1 is a block diagram illustrating the general system of the invention, according to an embodiment.

FIG. 2 is a flowchart illustrating the inputting of recognition data at a customer's device, according to an embodiment.

FIG. 3 is a flowchart illustrating actions that take place at the access device, according to an embodiment.

FIG. 4(a) illustrates inputting the recognition data at the recognition platform, according to an embodiment; FIG. 4(b) illustrates the of the recognition data to a manager or worker's device at the recognition platform, according to an embodiment.

FIG. 5 illustrates review of the recognition information at a manager or a worker's device, according to an embodiment.

FIG. 6 illustrates data entries in the worker database; according to an embodiment.

FIG. 7(a) illustrates data entries for workers in the recognition database, according to an embodiment. FIG. 7(b) illustrates data entries for an individual worker in the recognition database, according to an embodiment.

FIG. 8 is a block diagram illustrating one of the embodiments utilizing SMS messaging.

FIG. 9 is a flowchart illustrating inputting recognition data at a customer's device in one of the embodiment utilizing SMS messaging.

FIG. 10 is a flowchart illustrating activity at the access device in one of the embodiments utilizing SMS messaging.

FIG. 11 is a block diagram illustrating one of the embodiments utilizing a Customer Relationship Management system.

FIG. 12 is a flowchart illustrating inputting the recognition data at a customer's device in one of the embodiments utilizing a Customer Relationship Management system.

FIG. 13 is a flowchart illustrating activity at the access device in one of the embodiments utilizing the process of the Customer Relationship Management system.

FIG. 14 is a block diagram illustrating one of the embodiments utilizing Near Field Communications (NFC) technology.

FIG. 15 is a flowchart illustrating inputting the recognition data at a customer's device in one of the embodiments utilizing Near Field Communications (NFC) technology.

FIG. 16 is a flowchart illustrating activity at the access device in one of the embodiments utilizing Near Field Communications (NFC) technology.

FIG. 17 is a block diagram illustrating one of the embodiments utilizing a Bluetooth/Wifi/Beacon wearable device.

FIG. 18 is a flowchart illustrating inputting the recognition data that takes place at a customer's device in one of the embodiments utilizing a Bluetooth/Wifi/Beacon wearable device.

FIG. 19 is a flowchart illustrating activity at the access device in one of the embodiments utilizing a Bluetooth/Wifi/Beacon wearable device.

FIG. 20 is a block diagram illustrating one of the embodiments utilizing augmented reality and facial recognition.

FIG. 21 is a flowchart illustrating inputting the recognition data at a customer's device in one of the embodiments utilizing augmented reality and facial recognition.

FIG. 22 is a flowchart illustrating the steps at the access device in one of the embodiments utilizing augmented reality and facial recognition.

### DETAILED DESCRIPTION OF THE PREFERED EMBODIMENTS

Embodiments of the present invention are now described with reference to the figures, where like reference numbers indicate identical or functionally similar elements. Also in the figures, the left-most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

### I. Introduction

The invention described herein comprises a method, system, and computer program product that recognizes and rewards a worker's performance, achieved via a recognition platform. A customer who wishes to recognize or express extra appreciation to a worker may first request an identifier corresponding to the worker from the worker or a device of the worker. In some embodiments of the invention, the identifier can be the worker's initials, such an identifier may further include a combination of the abbreviation of their company's name with an automatically assigned numeric digit corresponding to the worker's profile, a signal from a nearfield communications (NFC) tag, or a signal broadcast by the worker's wearable Bluetooth or Wi-fi device, or an image of the worker (e.g., a facial image, a fingerprint, or some other biometric image). The customer may then send the identifier to an access device and receive, from the access device, access information (e.g., Uniform Resource Locator, or URL) for a profile of the worker residing on the recognition platform. In an embodiment, a Customer-Relationship Management (CRM), Point-of-Sale (POS), contact center system, website, chat system, email, etc. activated by an employee, customer, or a system may automatically send a custom employee recognition URL directly to the customer's mobile phone via Short Message Service (SMS) messaging, email, or chat system. The customer may then access the worker's profile and input the recognition data into the worker's profile. In some embodiments of the invention, the recognition data can be one or more of a token, a comment, a description of positive attributes, a video, or other form of recognition that can express the customer's appreciation. The worker, worker's manager, area manager, or corporate executives (e.g. C-suite) can also access the recognition platform to review the recognition information, as well as time logs and other information the platform may provide.

### II. Process

A. General

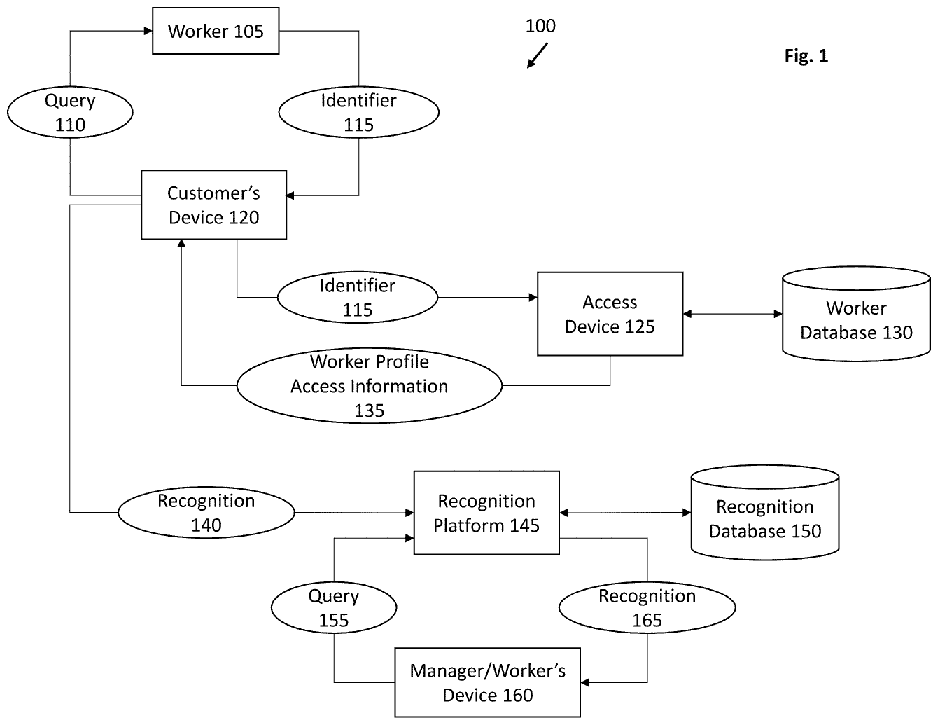

FIG. 1 illustrates the overall system 100 of the disclosed invention, according to an embodiment. First, a customer or a device used by the customer 120 may make a query 110 to the worker 105 for an identifier 115 corresponding to the worker. An identifier can be the worker's initials corresponding to the worker's profile, an NFC tag, a signal broadcast by the worker's wearable Bluetooth or Wi-Fi device, or an image or other biometric information of the worker that unambiguously identifies the worker. These are to be understood as examples of identifier 115, and are not meant to be limiting. A query 110 can be made by actively inquiring of the worker 105 for the identifier 115, by passively receiving a signal representing identifier 115, or through others means that enable the customer or his device 120 to receive the identifier 115 corresponding to the worker.

After receiving the identifier 115 from the worker 105, the customer, through a device 120, may send the identifier 115 to an access device 125. A device 120 of a customer can be a smart phone, a tablet, a computer, or other electronic device that enables the customer to access the recognition platform disclosed herein. The access device 125 may then communicate and exchange data with a worker database 130, retrieving access information 135 related to a profile of the worker, the profile residing on the recognition platform 145. The access information 135 can be a uniform resource locator (URL) that links to the worker's profile that resides on the recognition platform 145, an access key, or any other information that allows a customer to access the worker's profile. The worker database 130 may comprise a data structure that associates the identifier 115 corresponding to the worker 105 with the profile of the worker. The access device 125 may then send the access information 135 back to the customer's device 120.

The customer, using the access information 135, may access the worker's profile residing on the recognition platform 145 and input recognition data 140 into the worker's profile. Recognition data 140 can be a virtual token that represents gratitude or acknowledgement of the worker's performance, or may be a comment, a description of positive attributes, a video, a combination of these different forms of recognition, or other forms of recognition that can express the customer's appreciation and/or performance feedback. The recognition platform 145 may receive and record the recognition data 140 and store the recognition data 140 in a recognition database 150. The recognition database 150 may comprise a data structure that associates the recognition data with the worker. In one embodiment if assuming that the worker 105 has their privacy concerns addressed the worker 105 may share the recognition data 140 on another platform.

In an embodiment, an inquiry may later be entered by a worker, the through a device 160 of the worker. Here, the worker may make a query 155 to the recognition platform 145 for recognition information corresponding to the worker. A device 160 of a worker can be a smart phone, a tablet, a computer, or other electronic device that enables the worker to access the recognition platform 145 discussed above. The recognition platform 145 may then access the recognition database 150, retrieve the worker's recognition information previously provided by one or more customers, and send the recognition information 165 back to the worker's device 160.

An inquiry may also be entered by a manager or supervisor of the worker. The general processing may be analogous to that of the worker's query discussed above. In such an embodiment, the manager may use a device (also represented by block 160 of FIG. 1) to make such an inquiry. Here, the manager may send a query 155 to the recognition platform 145 seeking previous recognition information corresponding one or more workers. The device of a manager can be a smart phone, a tablet, a computer, or other electronic device that enables the manager to access the recognition platform disclosed in the invention. The recognition platform 145 may then access the recognition database 150, retrieve the recognition information previously provided by one or more customers, and send the recognition information 165 back to the manager's device.

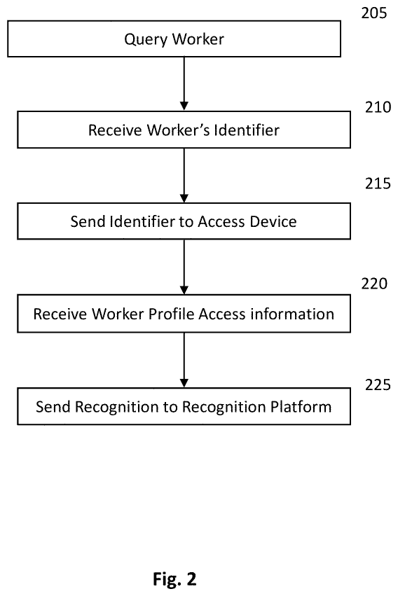

The process of providing recognition data at a device 120 of a customer is illustrated in FIG. 2, according to an embodiment. At 205, a customer may query a worker that the customer would like to recognize, to obtain an identifier corresponding to the worker. At 210, the customer may receive the identifier corresponding to the worker. Such a query and response may take place using any of the mechanisms described above. At 215, the customer, through a device of the customer (such as a smart phone or other communications device), may send the identifier to an access device. At 220, the customer may receive the access information (such as a URL or access key) for the worker's profile that resides on the recognition platform. At 225, the customer, through the device of the customer, may access the worker's profile using the access information. The profile may reside on the recognition platform. The user may then input the recognition data into the worker's profile on the recognition platform.

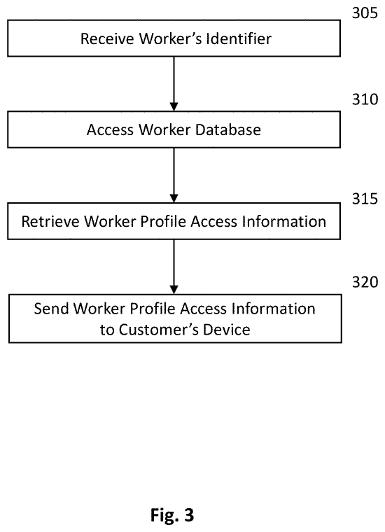

The process as it occurs at the access device 125 is illustrated in FIG. 3 according to an embodiment. At 305, the access device may receive, from a device of a customer, an identifier corresponding to a worker. At 310, the access device may access the worker database, which associates the identifier corresponding to the worker with a profile of the worker. As explained previously, the profile of the worker may reside on the recognition platform. At 315, the access device may retrieve the access information for the profile of the worker from the worker database. At 320, the access device may send the access information for the worker's profile back to the customer's device.

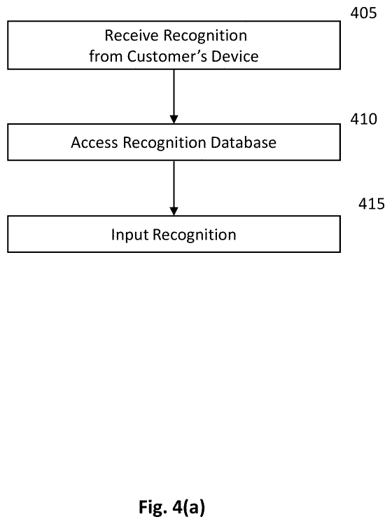

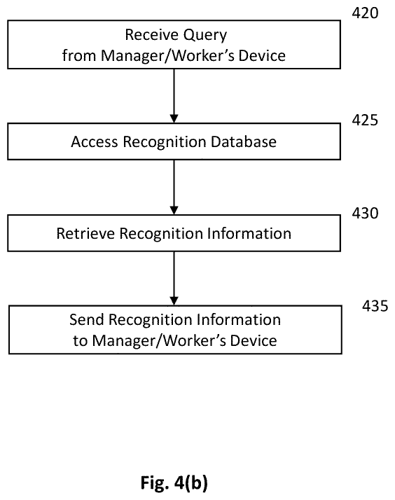

The process of receiving recognition data at the recognition platform 145 is illustrated in FIG. 4(a), according to an embodiment. At 405, the recognition platform may receive recognition data from a device of a customer. At 410, the recognition platform may access the recognition database, which may associate the recognition data with the worker. At 415, the recognition platform may write the recognition data into the worker database.

FIG. 4(b) illustrates the process that occurs at the recognition platform 145 during a query from a manger or a worker, according to an embodiment. At 420, the recognition platform may receive a query from a device of a manager, who is seeking recognition information for one or more worker. Such a query may also come from or a worker who wishes to see his recognition information. At 425, the recognition platform may access the recognition database, which associates the recognition data with the worker. At 430, the recognition platform may retrieve the recognition information corresponding to the worker(s) who is (are) the subject of the query. At 435, the recognition platform may send the recognition information corresponding to the queried worker(s) back to the device of the manager or the worker.

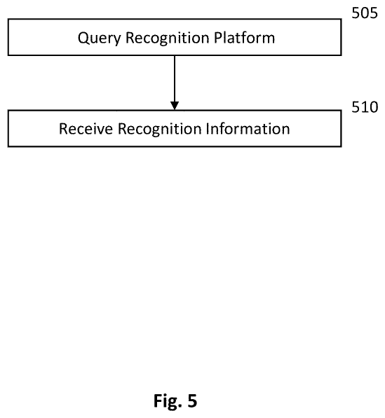

The process of querying recognition information at a device of a manger or a worker 160 is illustrated in FIG. 5 according to an embodiment. At 505, the manager or the worker, through his device, may query the recognition platform for recognition information of one or more workers. At 510, the device of the manager or the worker may receive the recognition information corresponding to the worker(s) from the recognition platform.

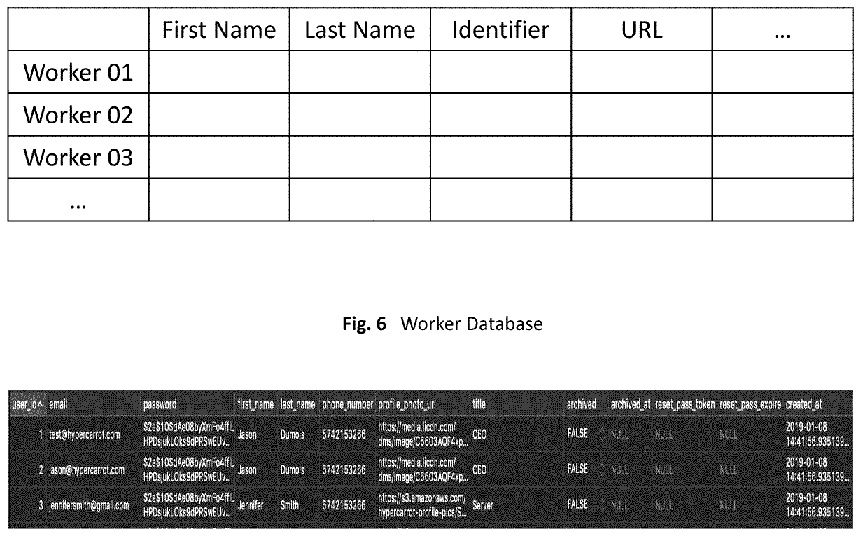

An example of the data entries in the worker database 130 of FIG. 1 is illustrated in greater detail in FIG. 6, according to an embodiment. The worker database may associate an identifier of a worker with access information for the profile of the worker. Information stored in the worker database may include but is not limited to personal information of a worker (e.g., first and last names), an identifier corresponding to the worker, access information such as a URL linked to the worker's profile residing on the recognition platform, and other relevant information.

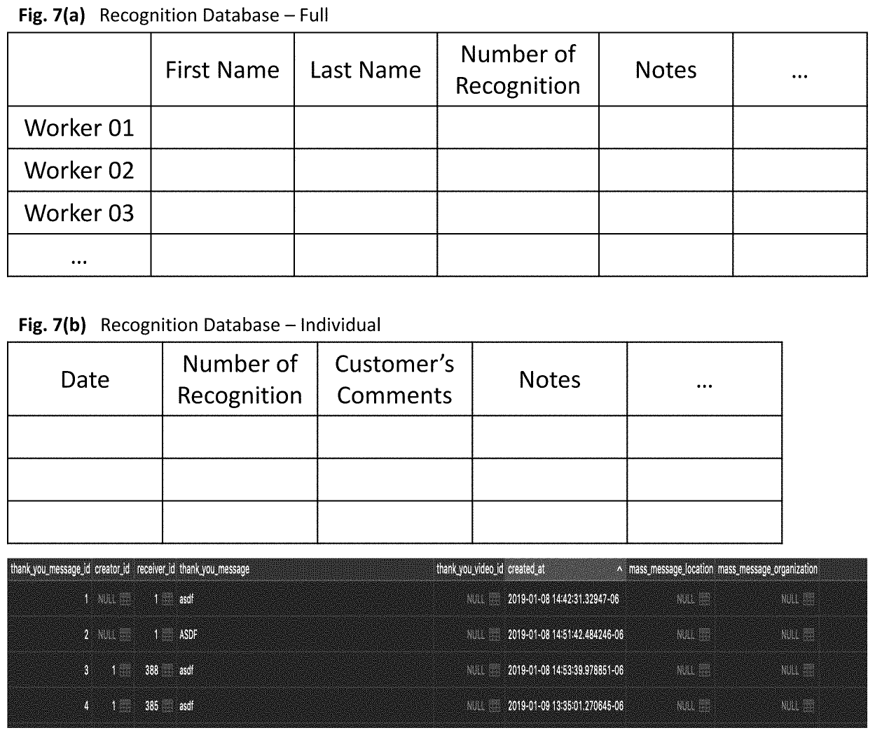

An example of the data entries in the recognition database is illustrated in FIGS. 7(a) and 7(b) according to an embodiment. FIG. 7(a) illustrates the association between the recognition information and the workers. Information stored in the recognition database may include but is not limited to a worker's personal information (e.g., name), number or amount of recognition (e.g., three stars, two thumbs up, four carrots), customer's comments, positive attributes, notes, videos, and/or other relevant information. In another embodiment, information stored in the recognition database may include FIG. 7(b) which illustrates two examples of the recognition information of an individual worker over time. The recognition information may be provided by one or more customers, as discussed above.

B. Particular Embodiments

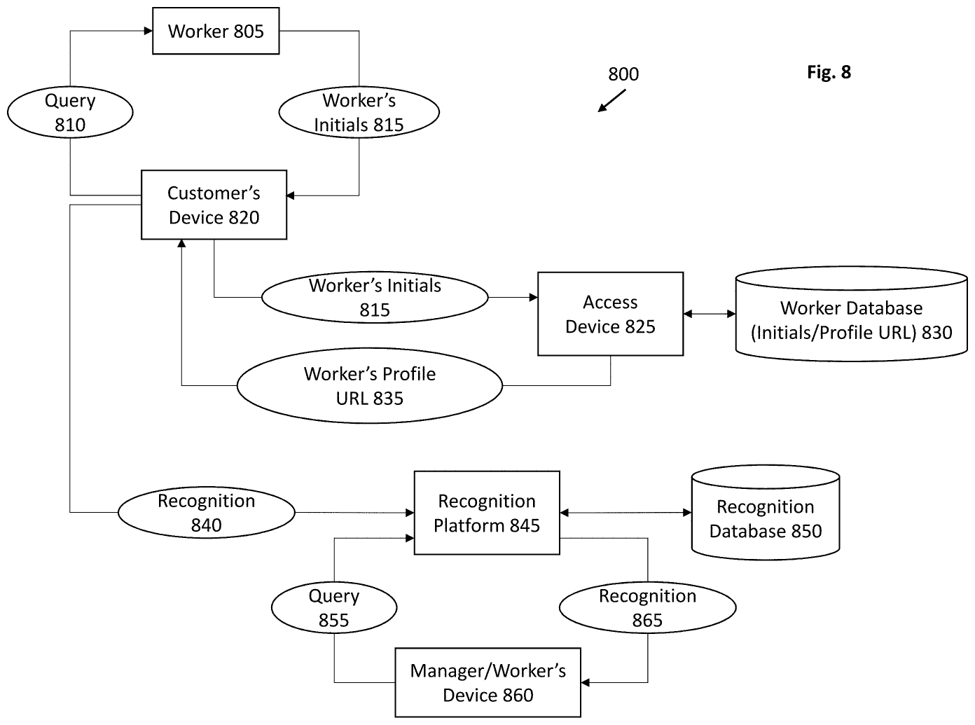

FIGS. 8-22 illustrate five particular embodiments of the invention. These various embodiments are provided as examples and thus should not be viewed as limiting. In the following descriptions of the various embodiments, the processes of receiving and recording the recognition data provided by a customer to the recognition platform, data exchange between the recognition platform and the recognition database, and querying and reviewing recognition information through a worker's or a manager's device are roughly analogous to general process discussed above and, therefore, will not be explained in as much detail.

FIG. 8 illustrates one embodiment 800. In this embodiment, the sending of an identifier of a worker to the access device and the receiving of access information for the worker's profile may be achieved through a short message service (SMS) system. The identifier in this embodiment may the worker's initials 815 or some other identifier. The identifier may also include an abbreviation for the employer company of the worker and any additional numbers to differentiate workers with the same initials. The customer 820 may first make a query 810 for the worker's identifier 815. This query may be electronic or verbal. A device 820 of the customer may send the received identifier of the worker via an SMS message to an access device 825. The access device 825 may access a worker database 830 that associates the worker's initials with a URL or other access information that allows access to a profile of the worker on the recognition platform 845. The access device 825 may then retrieve the URL or other access information. The access device 825 may then send the URL or other access information back to the customer's device 820. This communication may also take place via an SMS message 835.

The rest of the process in this first embodiment is largely similar to what is described in the general process above. The customer may access the worker's profile residing on the recognition platform 845 using the access information and may input recognition 840 into the recognition platform 845. The recognition platform 845 may store recognition data in a recognition database 850, which associates recognition data provided by one or more customers with a worker. A worker or a manager, through a device 860, can query 855 the recognition platform 845 and review the recognition information 865 in the same manner as described in the general process.

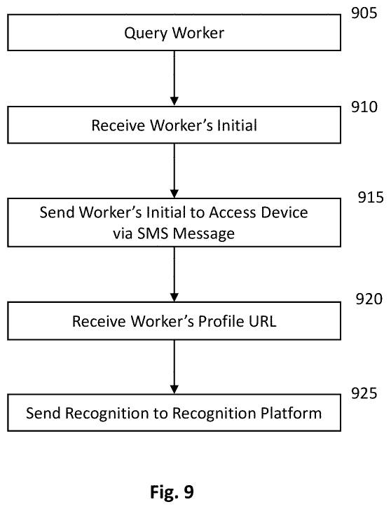

FIG. 9 illustrates the process of inputting of recognition data from a customer's device 820 in this embodiment. At 905, the customer may make a query for the worker's identifier, which may be the worker's initials in this embodiment. As explained previously, the identifier may also include an abbreviation for the worker's employer and/or other additional numbers to further identify the worker. The query can be done through verbally asking the worker or through other means that allow the customer to receive the worker's identifier. At 910, the customer may receive the worker's identifier. At 915, the customer, using his device, may send the worker's identifier to the access device via an SMS message. For example, the customer may send “ARJS1” for a worker named John Smith, who works at ABC Restaurants (AR), to“THANK” (84265) or another designated number using a smart phone using an SMS message. At 920, the customer, after sending the worker's identifier to the access device, may receive an SMS message with a URL or other access information that will lead the customer to the worker's profile residing on the recognition platform. At 925, the customer, using his device and the access information, may access the worker's profile on the recognition platform and input recognition data into the recognition platform.

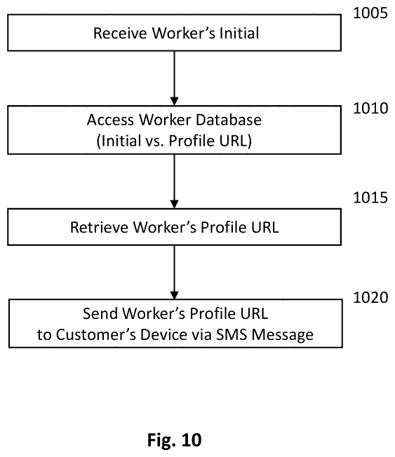

FIG. 10 illustrates the process occurs at the access device 825 in this first embodiment. At 1005, the access device receives the worker's identifier, i.e., the worker's initials and/or other additional numbers, via an SMS message. At 1010, the access device accesses the worker database that associates the worker's identifier to the URL that links to the worker's profile. At 1015, the access device retrieves the URL that links to the worker's profile residing on the recognition platform. At 1020, the access device sends the URL that links to the worker's profile back to the customer's device, via an SMS message. The customer may them provide recognition for the worker using this link.

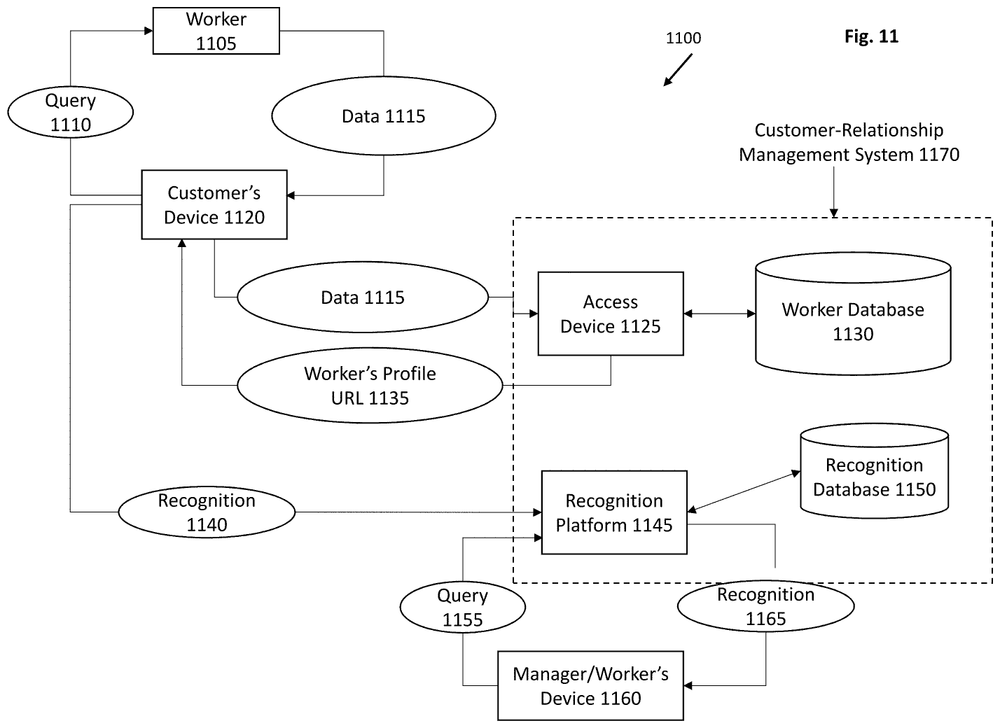

FIG. 11 illustrates another embodiment 1100 utilizing a Customer-Relationship Management (CRM) system. In this embodiment, the Customer-Relationship Management system 1170 may be, but is not limited to a point of sale, a contact center system, a website, a chat system or an email service that identifies the worker 1105 for recognition. In the illustrated embodiment, the CRM system 1170 may include some or all of the access device 1125, the worker database 1130, the recognition platform 1145, and the recognition database 1150. The customer 1120 may first make a query 1110 for the worker's identification (data 1115) through the Customer-Relationship Management system 1170. Such a query 1110 may be, but is not limited to verbal, written, or transmitted. In some embodiments the data 1115 is not submitted by the worker 1105, but sent directly to the customer's device 1120 from CRM system 1170. A device of a customer 1120 may then connect to the Customer-Relationship Management system 1170, and send the identifier (or signals corresponding thereto) to an access device 1125. The access device 1125 may then access a worker database 1130 through the Customer-Relationship Management system 1170 that associates the worker's identifier to an URL for a profile of the worker on the recognition platform 1145. The access device 1125 may then retrieve the URL. The access device 1125 then sends the worker's profile URL 1135 back to the customer's device 1120. The rest of the process in this embodiment is performed largely in a similar manner as described in the general process and thus will not be discussed in detail. In an alternative embodiment, the URL 1135 may be delivered directly to the device 1125 from the CRM system 1170 without the above query process.

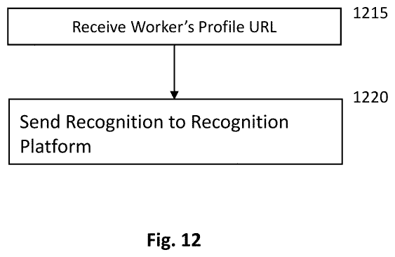

FIG. 12 illustrates the processing at the user's device in the context of a Customer-Relationship Management (CRM) system 1170 in an embodiment. In such a setting, there may be no explicit query for a worker's identifier, and the URL for the worker's profile may be sent directly to the user's device. At 1215, the access device may receive the URL. At 1220, the user's device may send recognition to the recognition platform.

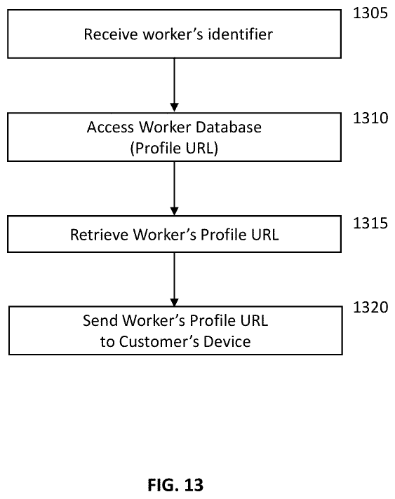

FIG. 13 illustrates the process that occurs at the access device 1125 in this embodiment. At 1305, the access device may receive the worker's identifier through various means, i.e., a link containing a website URL, a SMS with a link, a receipt with contact information, etc. At 1310, the access device may access the worker database that associates the worker's identifier to the URL that links to the worker's profile. At 1315, the access device may retrieve the URL that links to the worker's profile residing on the recognition platform. At 1320, the access device may send the URL back to the customer's device thereby directing the customer's device to the worker's profile on the recognition platform.

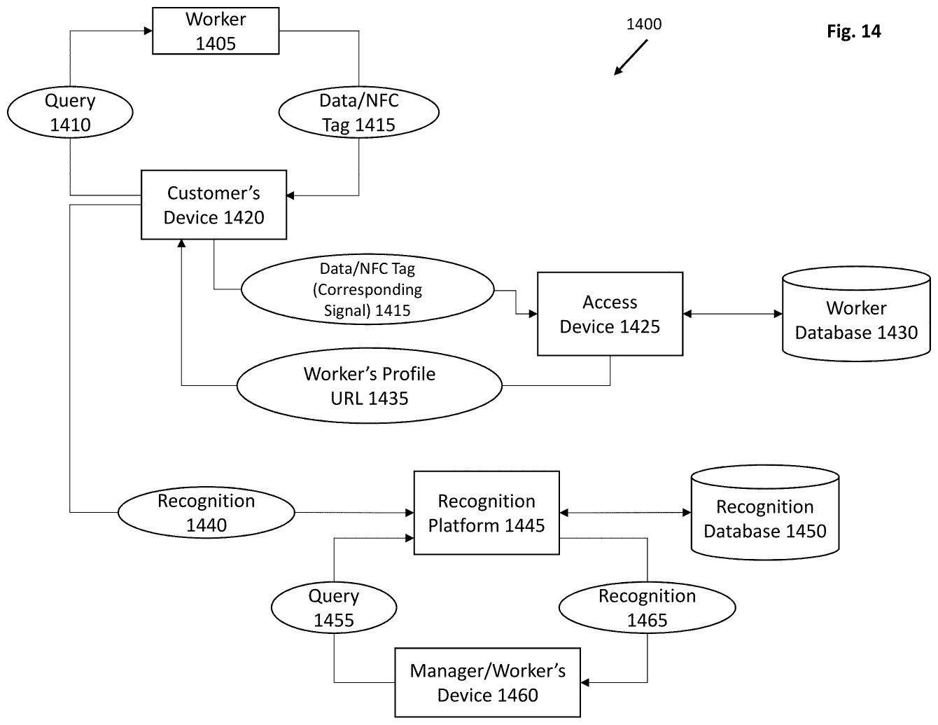

FIG. 14 illustrates another embodiment of the invention 1400 utilizing Near Field Communication (NFC) technology. In this embodiment, the identifier is an NFC tag (and a signal therefrom) assigned to and worn by a worker 1405. The customer 1420 may first make a query 1410 for the worker's identifier 1415, i.e., the NFC information of the worker 1405. To accomplish this, the device 1420 of a customer may query the NFC tag assigned to the worker, receive the information 1415 therefrom, and send this signal, to an access device 1425. The access device 1425 may then access a worker database 1430 that associates the worker's identifier 1415 to an URL that links to a profile of the worker, where the profile resides on the recognition platform 1445. The access device 1425 may then retrieve the URL, which represents access information for the worker 1405. The access device 1425 may then send the worker's profile URL 1435 back to the customer's device 1435. In an example of this embodiment, the customer's device 1420 may effectively be automatically directed to the worker's profile on the recognition platform after scanning the NFC tag corresponding to the worker. The rest of the process in this embodiment is performed largely in a similar manner as described in the general process and thus will not be discussed in detail.

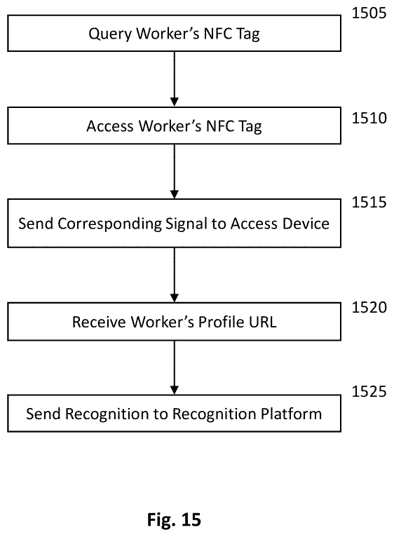

FIG. 15 illustrates the process of inputting recognition data by a customer's device 1420 in this embodiment. At 1505, the customer may make a query for the worker's identifier, which is the worker's NFC tag (and the signal therefrom) in this embodiment. At 1510, the customer may access the worker's NFC tag. At 1515, the customer, using his device, may send the worker's identifier, i.e., the corresponding NFC signal, to the access device. At 1520, the customer's device may receive the URL that links to the worker's profile residing on the recognition platform; the customer's device may thereby be automatically directed to the worker's profile. At 1525, the customer's device accesses the worker's profile on the recognition platform and inputs recognition data into the recognition platform.

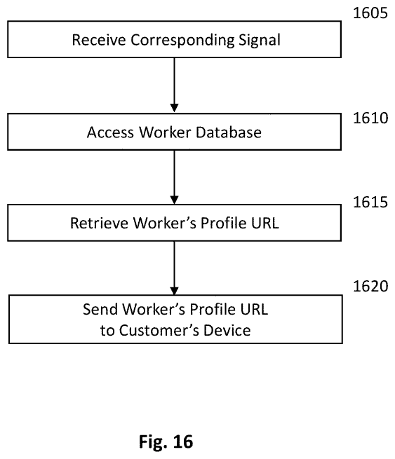

FIG. 16 illustrates the process occurring at the access device 1425 in this embodiment. At 1605, the access device may receive the worker's identifier, i.e., the signal corresponding to the worker's NFC tag. At 1610, the access device may access the worker database that associates the worker's identifier to the URL for the worker's profile. At 1615, the access device may retrieve the URL that links to the worker's profile, which resides on the recognition platform. At 1620, the access device may send this URL back to the customer's device and thereby direct the customer's device to the worker's profile.

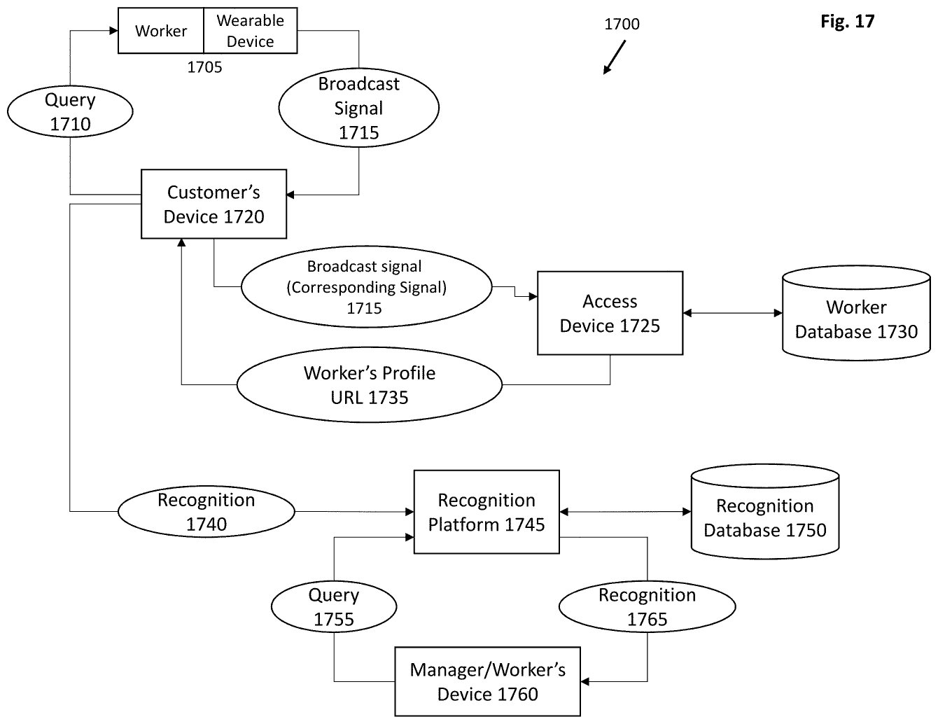

FIG. 17 illustrates another embodiment of the invention 1700. In this embodiment, the identifier may be a signal from a wearable device worn by a worker 1705 where the wearable device broadcasts a unique signal 1715 corresponding to the worker, through Bluetooth, WiFi, or a beacon. The customer 1720 may first make a query 1710 for the worker's identifier 1715. This query, in a practical scenario, may be a passive process done by the device 1720 of the customer. The customer's device 1720 may automatically pick up the signals broadcast by the worker's wearable device 1705. In some scenarios where the customer's device 1720 may detect multiple signals broadcast by multiple workers, for example, in a restaurant, the customer may then choose the worker he or she wants to recognize. A device of a customer 1720 may detect the signal broadcast by the worker's wearable device, connect to the worker's wearable or otherwise receives signals (i.e., the identifier 1715) from it, and send the identifier 1715 to an access device 1725. The access device 1725 may then access a worker database 1730 that associates the worker's identifier 1715 with a URL that links to a profile of the worker residing on the recognition platform 1745. The access device 1725 may then retrieve the URL. The access device 1725 may then sends the worker's profile URL back to the customer's device 1735. The rest of the process in this embodiment is performed largely in a similar manner as described in the general process above and thus will not be discussed in detail.

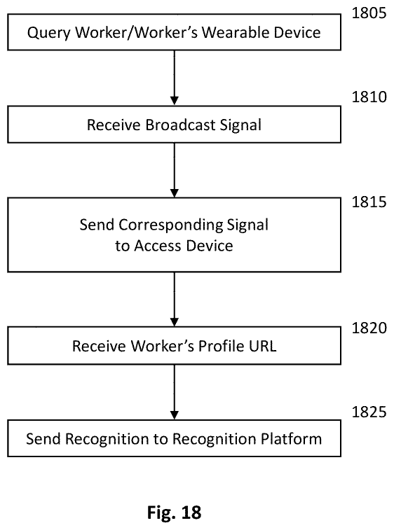

FIG. 18 illustrates the process of inputting recognition data by a customer's device 1720 in this embodiment. At 1805, the customer may make a query for the worker's identifier, i.e. wirelessly connecting to the worker's wearable device that broadcasts a unique signal corresponding to the worker. The signal may use Bluetooth, Wifi, or any known wireless protocol. This step may be a passive process in this embodiment as the customer's device will automatically detect the signals broadcast by the worker's wearable device. At 1810, the customer's device may detect and receive the signals broadcast by the worker's wearable device as the identifier. At 1815, the customer's device may send the identifier to an access device. At 1820, the customer's device may receive the URL that links to the worker's profile residing on the recognition platform. At 1825, the customer's device may use this URL to access the worker's profile on the recognition platform and input recognition data into the recognition platform.

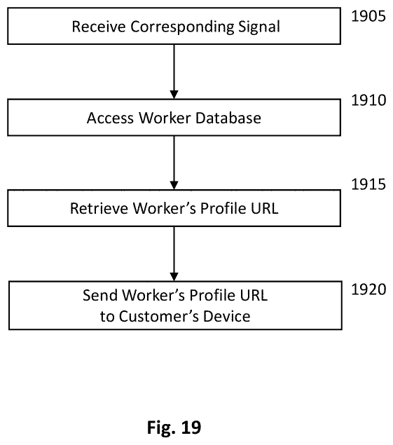

FIG. 19 illustrates the process occurring at the access device 1725 in this embodiment. At 1905, the access device may receive the worker's identifier, i.e., the signal corresponding to what was originally broadcast by the worker's wearable device, from the customer's device. At 1910, the access device may access the worker database that associates the worker's identifier to the URL for the worker's profile. At 1915, the access device may retrieve this URL. At 1920, the access device may send the URL back to the customer's device, allowing the customer to write to the recognition database.

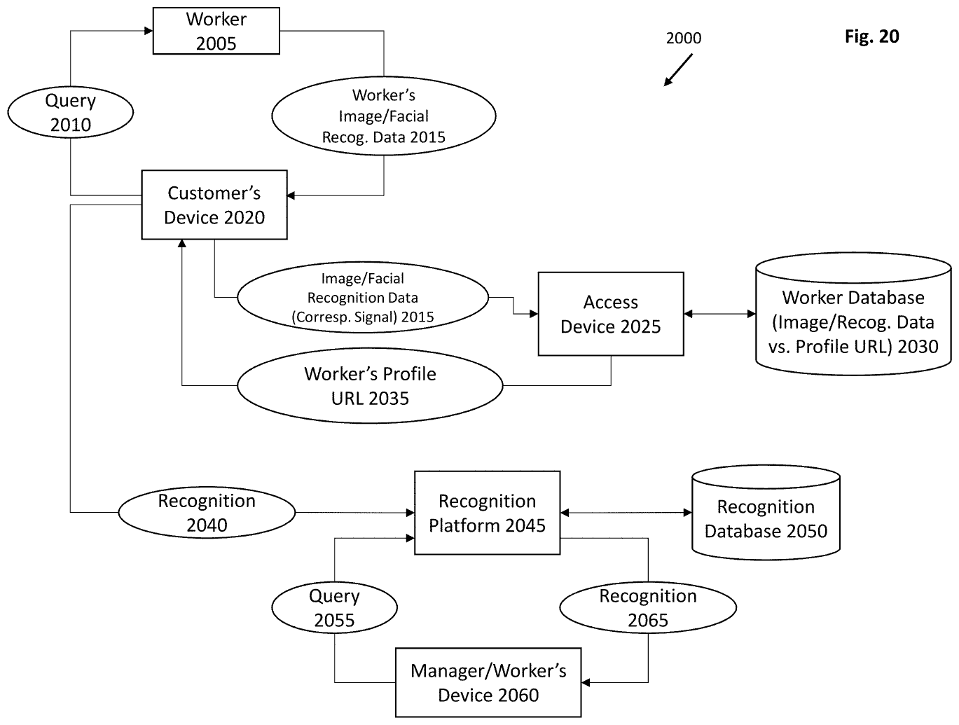

FIG. 20 illustrates another embodiment 2000 utilizing facial recognition or image recognition technology. In this embodiment, the identifier 2015 may be an image of the worker 2005 for image recognition, or the worker's facial characteristics such a purpose. The customer 2020 may first make a query 2010 for the worker's identifier 2015. Such a query may be verbal. The worker may provide the customer with an image of themselves, or they may let the customer scan their face to capture facial characteristics. A device of a customer 2020 may then scan the image or the worker's face, and send the identifier (or signals corresponding thereto) to an access device 2025. The access device 2025 may then access a worker database 2030 that associates the worker's identifier to an URL for a profile of the worker on the recognition platform 2045. The access device 2025 may then retrieve the URL. The access device 2025 then sends the worker's profile URL 2035 back to the customer's device 2020. The rest of the process in this embodiment is performed largely in a similar manner as described in the general process and thus will not be discussed in detail.

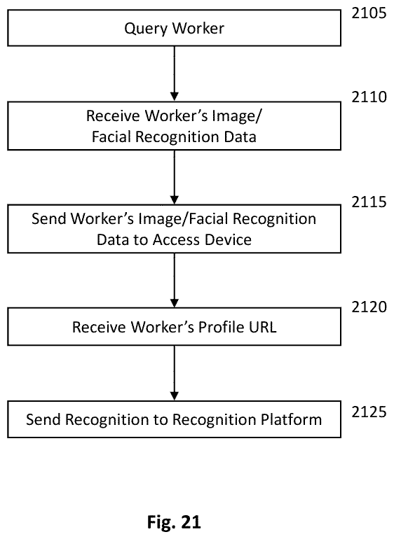

FIG. 21 illustrates the process of inputting recognition data at a customer's device 2020 in this embodiment. At 2105, the customer may make a query for the worker's identifier, i.e. an image of the worker or the worker's face. At 2110, the customer's device may receive the image of the worker as the identifier or may use the worker's facial characteristics as the identifier. At 2115, the customer's device may send the identifier or corresponding signals to an access device. At 2120, the customer's device may receive the URL that links to the worker's profile residing on the recognition platform. At 2125, the customer's device may access the worker's profile on the recognition platform and input recognition data.

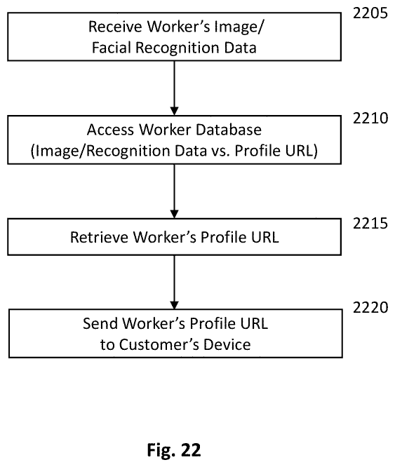

FIG. 22 illustrates the processing at the access device 2025 in this embodiment. At 2205, the access device may receive the worker's identifier, i.e., the worker's image or facial characteristics, or data corresponding to this. At 2210, the access device may access the worker database that associates the worker's identifier to the URL of the worker's profile. At 2215, the access device may retrieve the URL. At 2220, the access device may sends the URL back to the customer's device, which may allow the customer to provide recognition data to the recognition platform.

With regard to the system embodiments discussed above and illustrated, for example, in FIGS. 1, 8, 11, 14, 17, and 20, it is to be understood that some of the illustrated components may be combined. For example, in some embodiments, the access device and the recognition platform may be embodied as a single component. Such a component may have connectivity to both worker and recognition databases. Such a component may mediate access to both of these databases. Also, the recognition platform may incorporate the recognition database in some embodiments, and the access device may incorporate the worker database in some embodiments.

Moreover, connectivity between any of the components may be implemented over any known communications mechanism(s) and infrastructures, including, for example, local or wide area networks or the Internet. Such communications may be implemented using any communications protocol known to those of ordinary skill in the art.

In addition, the processing as described above may be implemented using hardware, firmware, software, or any combination thereof. Each of the user device, the access device, and the recognition platform may include one or more programmable processors. In each these devices, the processor may be connected to a communication bus. In each, the processor may be connected to a main or primary memory, such as random access memory (RAM). The primary memory may have stored therein control logic (computer software) that controls the processing described above, and data. The software may be stored on a computer useable or readable storage medium, from which executable instructions are read in a well-known manner.

The customer device, access device, and recognition platform may each include a communication or network interface. The network interface enables the device to communicate with the other devices. In various embodiments, the software may be communicated to the devices via carrier waves (electromagnetic or optical signals) that are modulated with the control logic.

Any apparatus or manufacture comprising a computer useable or readable medium having control logic (software) stored therein is referred to herein as a computer program product or program storage device. This includes, but is not limited to, a processor, main memory, a hard disk, a removable storage unit, and/or carrier waves modulated with the control logic. Such computer program products, having control logic stored therein that, when executed by one or more processor, cause the above devices to operate as described herein in various embodiments. Any software, hardware, and operating system implementations suitable for performing the functions described herein can be used.

### III. Conclusion

While various embodiments of the present invention have been descried above, it should be understood that they have been presented by way of example, and not limitation. It will be apparent to persons skilled in the relevant art that various changes in detail can be made therein without departing from the spirit and scope of the invention. Thus, the present invention should not be limited by any of the above-described exemplary embodiments, but should be defined only in accordance with the following claims and their equivalents.

What is claimed is:

1. A method performed at a device of a customer, comprising:
sending an identifier corresponding to a worker to an access device;
receiving, from the access device, access information for a profile of the worker; and
using the access information to input recognition data to the profile of the worker.

2. The method of claim 1, wherein the profile of the worker resides on a recognition platform.

3. The method of claim 1, further comprising:
receiving the identifier from a device of the worker,
performed before the sending.

4. The method of claim 3, further comprising:
querying the device of the worker, to request the identifier,
performed before the receiving of the identifier.

5. The method of claim 1, wherein the device of the customer is one of a smartphone, a tablet, or a computer.

6. A method performed at an access device, comprising:
receiving an identifier corresponding to a worker from a device of a customer;
accessing a worker database in communication with the access device;
retrieving, from the worker database, access information for a profile of the worker using the identifier; and
sending the access information to the device of the customer.

7. The method of claim 6, wherein the worker database comprises:
a data structure that associates identifiers corresponding to one or more respective workers, with the respective profiles of the workers.

8. The method of claim 6, wherein the device of the customer is one of a smartphone, a tablet, or a computer.

9. The method of claim 6, wherein the access information comprises a uniform resource locator (URL).

10. A method performed at a recognition platform, comprising:
receiving recognition data regarding performance of a worker, from a device of a customer;
accessing a recognition database; and
inputting the recognition data into a profile of the worker at the recognition database.

11. The method of claim 10, wherein the recognition database comprises:
a data structure that associates the worker with a profile of the worker.

12. The method or claim 10, further comprising:
receiving a query from a device of the worker or a device of a manager;
accessing the recognition database in response to the query;
retrieving the recognition data corresponding to the worker; and
sending the recognition data to the device of the worker or the device of the manager.

13. The method of claim 12, wherein each of the device of the worker and the device of the manager is one of a smartphone, a tablet, or a computer.

14. A method performed at a device of one of a worker or a manager of the worker, comprising:
accessing the worker's profile on a recognition platform;
receiving recognition information from the recognition platform, wherein the recognition information was provided to the recognition platform by a customer.

15. The method of claim 14, wherein the device is one of a smartphone, a tablet, or a computer.

16. A recognition system for recognizing a worker for their performance, comprising:
an identifier corresponding to a worker, sent by a device of a customer, that enables retrieving access information for a profile of the worker;
an access device configured to receive, from the device of the customer, the identifier corresponding to the worker, retrieve the access information for the profile of the worker, and send the access information for the profile of the worker to the device of the customer; and
a recognition platform configured to receive and record recognition data from the device of the customer.

17. The recognition system of claim 16, further comprising:
a worker database in communication with the access device and configured to store the access information and associate the identifier corresponding to the worker with the access information; and
a recognition database, in communication with the recognition platform, configured to store the recognition data input by the device of a customer, and to associate the recognition data with the worker.

18. The recognition system of claim 16, wherein the recognition platform is further configure to receive a query from a device of a manager or a worker, and to send the recognition information corresponding to the worker to the device of the worker or the device of the manager.
